(19) United States
(12) Patent Application Publication
(10) Pub. No.: US 2002/0175508 A1
(43) Pub. Date: Nov. 28, 2002

(54) Counter flow inflator

(76) Inventors: Travis B. Hess, Farr West, UT (US); Thomas J. Russell, Ogden, UT (US)

Correspondence Address: Sally J. Brown, Autoliv ASP, Inc., 3350 Airport Road, Ogden, UT, 84405, US

(21) Appl. No.: 09/864,964

(22) Filed: May 24, 2001

(51) Int. Cl. B60R 21/28

(52) U.S. Cl. 280/740

(57) ABSTRACT

An inflator having a body, an aperture in the body, and a diffuser housing is disclosed. The body has, or forms, an interior cavity, which may contain gas or gas generant material. The gas generant material is capable of producing gas to inflate, for example, an airbag. A diffuser housing is situated around at least a portion of the body and, in cooperation with the body, forms a gas flow channel. When the gas or gas generant material releases gas, the gas flows from the cavity, through the aperture, into the channel, and exits the channel into an airbag, cooling the gas before it enters the airbag. The inflator may also have an indentation capable of receiving a clamp. The clamp may be secured over an airbag and seated in the indentation to secure the inflator within an airbag. When the inflator is actuated, the gas is pushed away from the inflator such that the inflator is thrust towards the clamp, thereby pushing a broadening portion of the indentation against the clamp and securing the seal between the air bag and the inflator.

### BACKGROUND OF THE INVENTION

1. Field of the Invention

The present invention relates to an airbag inflation apparatus and method and, more specifically, to an apparatus and a method for cooling and diffusing gas injected into an airbag while simultaneously providing a superior seal between the airbag and the inflator at the moment of inflation.

1. Technical Background

Inflatable airbags are well accepted in their use in motor vehicles and have been credited with preventing numerous deaths and accidents. Some statistics estimate that frontal airbags reduce fatalities in head-on collisions by 25% among drivers using seat belts and by more than 30% among unbelted drivers. Statistics further suggest that with a combination of seat belt and airbag, serious chest injuries in frontal collisions can be reduced by 65% and serious head injuries by up to 75%. Thus, airbag use presents clear benefits.

Airbags may be positioned in a variety of locations throughout the vehicle. Airbags located within the steering wheel aid in preventing the driver from striking the steering wheel and the windshield in the event of an accident. Airbags have also been placed in the dashboard directly in front of the passenger seat in a vehicle. More recently, airbags have been installed on the side portions of the vehicle in order to prevent the occupants from striking the doors and windows in the vehicle when an accident throws the occupant in that direction. This type of airbag is frequently referred to as an inflatable curtain. Airbags have also been placed in seat belts, creating what has been termed inflatable seat belts. Knee bags have also been created to prevent an occupant's lower body from striking the vehicle.

Previously, sensors were placed in a vehicle's bumpers to determine when to deploy the airbag. A modem airbag apparatus, however, may include an electronic control unit (ECU) and one or more airbag modules. The ECU is usually installed in the middle of an automobile, between the passenger and engine compartment. If the vehicle has a driver's side airbag only, the ECU may be mounted in the steering wheel. The ECU includes a sensor that continuously monitors the acceleration and deceleration of the vehicle and sends this information to a processor which analyzes an algorithm to determine whether the vehicle is in an accident.

When the processor determines that there is an accident situation, the ECU transmits an electrical signal to an initiator in the airbag module. The initiator triggers operation of the inflator. The inflator inflates a textile airbag to prevent injury to the passenger. In some airbag apparatuses, the airbag may be fully inflated within 50 thousands of a second and deflated within two tenths of a second. Tremendous force is required to inflate the airbag so quickly.

Airbag inflators come in a number of different varieties. Some inflators, termed “stored gas inflators,” simply store the gas in a high-pressure state, and open to release the gas during impact. “Pyrotechnic” inflators, by contrast, do not store gas; rather, they contain propellants that, upon ignition, react to produce the gas. “Hybrid” inflators utilize compressed gas in combination with pyrotechnics to produce the gas. In some instances, the pyrotechnic can also serve to open the inflator to permit the gases to escape. Whatever the type of inflator, tremendous pressure and heat are generated at the moment of impact, potentially rupturing the airbag. Naturally, such damage to the airbag may render it entirely ineffective.

Airbag inflators have been placed in a number of different positions relative to the airbag. For example, with respect to a side impact bag, the inflator is frequently located at a position remote to the airbag (because of space limitations), and then connected to the airbag via a conduit. Another genre of side-impact airbags places the inflator partially or entirely within the inflatable curtain, obviating the need for a conduit. Such a system can be superior as it eliminates the conduit, which can rupture or deteriorate over time, once again rendering the airbag ineffectual. Also, eliminating the conduit accelerates the inflation process by eliminating this additional, now-largely-unnecessary aspect of a side-impact bag.

Under either system, there is a need to diffuse and cool the gas prior to injecting it into the airbag. This need is particularly acute when the inflator is actually located within the airbag. In such a configuration, the gas is injected into the airbag soon after it is generated and when the gas is hot and proceeding with great force.

To remedy this problem, the gas outlet diffuser was developed. The gas outlet diffuser is frequently attached on the end of the inflator. The gas outlet diffuser is frequently comprised of a circular cap having a series of orifices around the sides of the cap. The top of the gas outlet diffuser does not have any holes. Thus, the gas is injected into the outlet diffuser so that the gas immediately strikes the top of the gas outlet diffuser, and is then forced out the orifices along the sides of the diffuser and out the holes. Thus, the temperature and force of the gas is controlled and reduced.

While the gas outlet diffuser provides some protection, greater diffusion and cooling are desired to fully protect the airbag. Greater cooling and diffusion would permit the airbag to inflate more safely and more rapidly, while minimizing the danger of a rupture. Providing additional cooling and diffusing, while adding minimal cost to the inflator, would be a significant advancement in the art.

An additional problem arises when the inflator is inserted in the airbag. It is difficult to create a tight seal between the inflator and the airbag. At the moment of inflation, tremendous forces are exerted both on the airbag and the inflator, pushing them in various directions and potentially breaking the seal between the airbag and the inflator. Obviously, if such a leak arises, the airbag may not inflate at all or may inflate inadequately. Failures of this type present dangers to the consumer.

Thus, it would be in advancement in the art if a method and apparatus could be developed that enhances the seal between the inflator and the airbag. It would be a further advancement if such a system would simultaneously cool and diffuse the inflator air, minimizing the danger of attendant ruptures to the airbag. This advancement would significantly be enhanced if implemented in a cost-effective manner.

Such a device is disclosed and claimed herein.

### BRIEF SUMMARY OF THE INVENTION

The apparatus and methods of the present invention have been developed in response to the present state-of-the-art, and, in particular, in response to problems and needs in the art that have not yet been fully resolved by currently available airbag inflator systems. Thus, it is an overall objective of the present invention to provide an apparatus for enhancing the effectiveness of airbag inflator systems.

To achieve the foregoing objects, and in accordance with the invention as embodied and broadly described in the preferred embodiment, an airbag inflator system diminishing the risk of airbag leaks or ruptures is provided.

In the present invention, an inflator, having a proximal end and a distal end, may include a body, an aperture disposed in the body, and a diffuser housing. Gas exits the inflator near its distal end, while the proximal end may house an initiator in electrical communication with the electronic control unit, which determines when accident conditions exist. In one embodiment, when the inflator is inserted into an airbag, the distal end of the inflator is located within the airbag, while the proximal end may be positioned just outside of the airbag.

The body may comprise an interior cavity. The interior cavity is configured such that it is capable of containing a quantity of gas generant material. Gas generant material is any material capable of producing gas to inflate an airbag. As discussed above, there are various methods of generating such gas, including stored-gas, pyrotechnic, or hybrid methods.

At least one aperture is disposed within the body. At the moment of inflation, gas generated in the cavity flows through the aperture. In one embodiment, a plurality of apertures are disposed within the body.

The apertures differ from those found in conventional gas outlet diffusers. A conventional gas outlet diffuser is usually placed at the end of the inflator body such that the gas flows directly from the outlet diffuser into the airbag. In contrast, the apertures of the present invention are integrated with the body, sometimes being placed between various parts of the body (e.g., between various chambers in the body or a chamber and the initiator). The placement of the apertures permits the body to be used to cool and diffuse the inflator gas before it enters an airbag. Thus, the gas flows across the body before exiting the inflator.

A diffuser housing may be disposed about at least a portion of the body and in cooperation with the body, forms a gas flow channel. The gas flow channel is configured such that upon operation of the inflator, gas flows from the cavity, through the aperture, into the channel, and exits the channel near the distal end of the inflator. The aperture places the interior cavity in gaseous communication with the channel.

The gas flow channel is most effective when it employs a large portion of the body to cool and diffuse the gas. Thus, the gas should enter the channel near the proximal end and exit the channel near the distal end of the inflator. In one embodiment, the gas flow channel is at least one-half the length of the inflator. The length of the inflator may be defined as the distance from the proximal end to the distal end of the inflator.

The present invention implements a counter flow concept. As gas is generated or released, at least a portion of the gas flows in one direction while in the cavity, but flows in an opposite, or nearly opposite direction, while traveling through the gas flow channel. Thus, the gas abruptly changes directions, resulting in significant cooling and diffusion of the gas. The addition of a gas flow channel to the inflator provides cooling and diffusion in a manner not previously known in the art. It is conventional to place a gas outlet diffuser (a group of apertures) on the end of the inflator to diffuse the gas. Thus, conventional inflators fail to take advantage of the counter flow concept.

In one embodiment, the gas flow channel is not straight, but involves a turn or change in direction. Thus, even after the gas enters the diffuser channel, it is forced to change directions, further cooling and diffusing the gas. In one embodiment, the gas flow channel may be configured such that there are other additional turns or changes in direction, resulting in enhanced cooling and diffusing.

Simultaneously with cooling and diffusing the gas, this invention secures the seal between the inflator and the airbag at the moment of inflation. In the present invention, the housing also comprises an indentation. The indentation may comprise a narrow section and a broadening section, the narrow section abutting the broadening section and being situated between the proximal end and the broadening section.

A clamp secures the narrow section of the housing within an inlet of an airbag. In one embodiment, the airbag may be an inflatable curtain. The inlet of the airbag or inflatable curtain is configured to surround and receive at least a portion of the inflator.

When the inflator is actuated, gas exits the body through the aperture and is directed through the channel into the airbag in a direction away from the proximal end such that the broadening section is pushed against the clamp, thereby tightening the seal between the inflator and airbag. Ideally, the clamp will be placed on the portion of the narrow section immediately adjacent to the broadening section. Such placement ensures that the broadening section will be rapidly pushed against the clamp, enabling the seal to be tightened at the earliest possible moment.

The gas flow channel directs the gas pushed from the inflator in a direction away from the proximal end of the inflator, thus pushing the inflator towards the clamp. Some conventional inflators employing a gas outlet diffuser pushed the gas in different directions away from the inflator and thus failed to take advantage of this innovation. In the present invention, while the apertures may direct the gas in different directions, the gas flow channel then turns and directs the gas from the apertures in the same direction, creating the force necessary to secure the seal between the inflator and the airbag. Therefore, the gas pushed from the inflator must be properly directed so as to push the broadening section of the indentation against the clamp.

This invention presents a significant advancement in the art in that, at the moment of inflation, it simultaneously secures the seal between the airbag and the inflator, and diffuses and cools the gas employed to inflate an airbag. As a consequence, each aspect of this invention works together to ensure that the airbag safely and reliably deploys free of ruptures or leaks. Moreover, the counter flow inflator cools and diffuses the gas in a compact space in an innovative and previously unknown and more efficient way.

These and other advantages of the present invention will become more fully apparent from the following description and appended claims, or maybe learned by the practice of the invention as set forth hereinafter.

### BRIEF DESCRIPTION OF THE DRAWINGS

In order that the manner in which the advantages and features of the invention are obtained, a more particular description of the invention summarized above will be rendered by reference to the appended drawings. Understanding that these drawings only provide selected embodiments of the invention and are not therefore to be considered limiting in scope, the invention will be described and explained with additional specificity and detail through the use of the accompanying drawings in which:

FIG. 1 is a cross-sectional view of one embodiment of this invention.

FIG. 2 is a cross-sectional view of one embodiment of this invention taken across line 2-2 from FIG. 1.

FIG. 3 is a cross-sectional view of one embodiment of this invention shown in conjunction with an inflatable curtain.

### DETAILED DESCRIPTION OF THE PREFERRED EMBODIMENTS

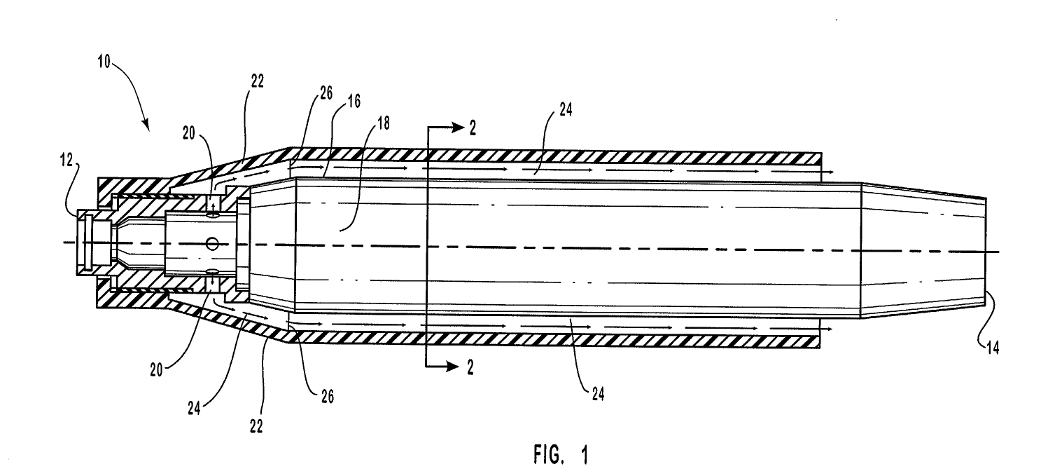

The preferred embodiments of the invention are now described with reference to FIGS. 1-3, where like reference numbers indicate identical or functionally similar elements. The members of the present invention, as generally described and illustrated in the Figures, may be implemented in a wide variety of configurations. Thus, the following more detailed description of the embodiments of the system and method of the present invention, as represented in the Figures, is not intended to limit the scope of the invention, as claimed, but is merely representative of presently preferred embodiments of the invention.

FIG. 1 is a cross-sectional view of one embodiment of the invention. The invention comprises an inflator 10, which produces gas to inflate, for example, an airbag. An airbag is an enclosure designed to fill with gas in the event of an accident. Ideally, an occupant of the vehicle strikes the airbag instead of the hard and less forgiving surfaces within the vehicle.

The airbag comprises a proximal end 12 and a distal end 14. In one embodiment, the inflator 10 is capable of being disposed within an airbag. When inserted into an airbag, the distal end 14 of the inflator 10 is positioned within the airbag, while the proximal end 12 may be positioned outside of the airbag. In another embodiment, the proximal end 12 may be positioned inside the airbag but close to an opening in the airbag. As illustrated in FIG. 1, the gas exits the inflator 10 near the distal end 14. In some embodiments, the proximal end 12 houses an initiator and is connected to wiring, placing the inflator 10 in electrical communication with an electronic control unit (ECU). As stated before, the ECU determines when accident conditions exist and sends an electrical signal to the inflator 10 actuating the inflation process.

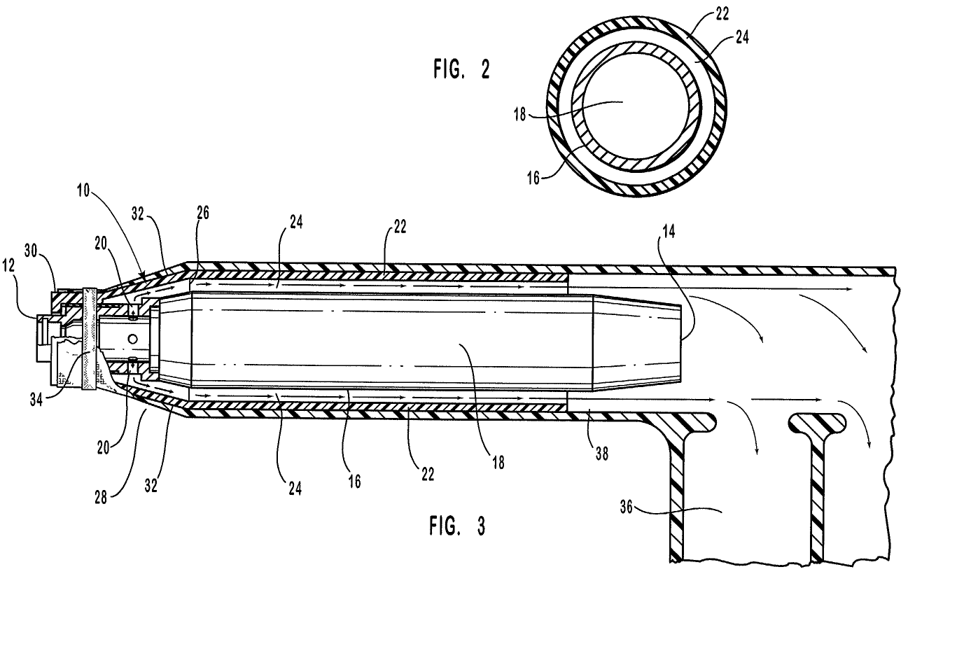

The inflator 10 further comprises a body 16. In one embodiment, the body 16 is substantially cylindrical. Substantially cylindrical means that more than half of the body forms a circular, or roughly circular, cross-sectional shape where a plane perpendicular to the length of the inflator 10 defines each cross-sectional shape. The length of the inflator 10 is the dimension from the proximal end 12 to the distal end 14 of the inflator 10. Such a circular cross-sectional shape is illustrated by FIG. 2, which is discussed below. The body 16 forms, or has, an interior cavity 18. The interior cavity 18 is configured such that it is capable of containing a quantity of gas generant material.

Gas generant material is any material capable of producing gas to inflate an airbag. As discussed above, there are various methods of generating gas to inflate an airbag, including stored-gas, pyrotechnic, or hybrid methods. Stored gas inflators simply store compressed gas that is released during an accident. “Pyrotechnic” inflators, by contrast, do not store gas; rather, they contain solid gas generant (e.g., sodium azide or similar material) that, upon ignition, reacts to produce the gas. “Hybrid” inflators utilize compressed gas in combination with pyrotechnics to produce gas. As stated before, in some instances, the ignition of solid gas generant can also serve to open a compartment in an inflator 10, permitting gas to escape and flow into an airbag. The method through which the gas is produced is not a limiting factor of the present invention. Those skilled in the art are familiar with numerous ways of producing the gas necessary to inflate an airbag.

At least one aperture 20 is disposed within the body 16. An aperture 20 is an opening in the body 16 and may be configured in many different shapes (e.g., circular or rectangular). The aperture 20 is configured, or positioned, such that gas may flow from the cavity 18 through the aperture 20. In one embodiment, a plurality of apertures 20 are disposed within the body 16. The apertures 20 may be located closer to the proximal end 12 of the inflator 10 than to the distal end 14.

A diffuser housing 22 may be disposed about at least a portion of the body 16 and in cooperation with the body 16 forms a gas flow channel 24. The gas flow channel 24 is configured such that upon operation of the inflator 10, gas flows from the cavity 18, through the aperture 20, into the channel 24, and exits the channel 24 near the distal end 14 of the inflator 10. The aperture 20 places the interior cavity 18 in gaseous communication with the channel 24. The positioning of the apertures 20 is related to the practice of this invention. If the apertures 20 are placed close to the distal end 14 of the inflator 10, the defusing and cooling effect of the gas flow channel 24 will be diminished.

The diffuser housing 22 assists in cooling and diffusing the gas. In the embodiment illustrated in FIG. 1, as gas moves from the apertures 20, it makes contact with the diffuser housing 22. The diffuser housing 22 turns and directs the gas along the body 16, thus cooling and diffusing the gas.

The gas flow channel 24 is most effective when it employs a large portion of the body 16 to cool and diffuse the gas. Thus, the gas should preferably enter the channel 24 near the proximal end 12 and exit the channel 24 near the distal end 14 of the inflator 10. In one embodiment, the gas flow channel 24 is at least one-half the length of the inflator 10. The length of the inflator 10 may be defined as the distance, or dimension, from the proximal end 12 to the distal end 14 of the inflator 10. In the embodiment shown in FIG. 1, the gas flow channel 24 is about three-fourths the length of the inflator 10.

This invention implements a counter flow concept. As gas is generated or released, at least a portion of the gas flows in one direction while in the cavity 18, but flows in an opposite, or nearly opposite direction, while traveling through the gas flow channel 24. Thus, the gas abruptly changes directions, resulting in significant cooling and diffusion of the gas. The addition of a gas flow channel 24 to the inflator 10 provides cooling and diffusion in a manner not previously known in the art. Conventional gas outlet diffusers (a group of apertures or orifices) are often positioned on the end of the inflator to diffuse the gas. Thus, conventional inflators fail to take advantage of the counter flow concept. Moreover, the counter flow inflator 10 cools and diffuses the gas in a compact space, employing conventional elements in an innovative, previously unknown and more efficient way.

The gas flow channel 24 is configured such that upon operation of the inflator 10, gas flowing out of the inflator 10 is cooled as it flows through the channel 24. The gas flow channel 24 provides diffusing benefits beyond the counter flow concept. As shown in FIG. 1, the gas flow channel 24 is not straight, but involves a turn or change in direction 26. Thus, even after the gas enters the diffuser channel 24, it is forced to change directions, further cooling and diffusing the gas. In one embodiments, the gas flow channel 24 may be configured such that there are other additional turns or changes in direction, resulting in enhanced cooling and diffusion.

FIG. 2 is a cross-sectional view of one embodiment of this invention taken across line 2-2 from FIG. 1. More specifically, this Figure depicts a cross-sectional view of the gas flow channel 24 formed by the inflator body 16 and housing 22. As stated above, in one embodiment, the inflator 10 comprises a body 16 having an interior cavity 18 and an aperture 20 disposed in the body 16. A diffuser housing 22 is disposed about at least a portion the body 16 and in cooperation with the body 16 forms a gas flow channel 24. When the inflator 10 is actuated, gas flows from the cavity 18, through the aperture or apertures 20, into the channel 24, and exits the channel 24 near the distal end 14 of the inflator 10.

FIG. 3 is a cross-sectional view of one embodiment of this invention shown in conjunction with an airbag 36. In the embodiment shown, the airbag 36 is an inflatable curtain. The inflatable curtain frequently deploys from a location just above the door of a vehicle and expands to cover at least a portion of the door or side window of the vehicle to prevent the occupant from striking that portion of the vehicle. The airbag 36 may have an inlet 38 configured to surround and receive at least a portion of the inflator 10.

In the embodiment shown in FIG. 3, the housing 22 further comprises an indentation 28 configured such that it is capable of receiving a clamp 34. The indentation 28 may comprise a narrow section 30 and a broadening section 32, the narrow section 30 abutting the broadening section 32 and being situated between the proximal end 12 and the broadening section 32. The cross-sectional shape of the broadening section 32 increases in size in a direction away from the narrow section 30. (Here again, a plane perpendicular to the length of the inflator 10 defines each cross-sectional shape.) In one embodiment, the cross-sectional shape of the broadening section 32 maintains the same proportional shape (e.g., circular or rectangular) as the cross-sectional shape of the narrow section 30, but merely increases in size. In another embodiment, the indentation 28 may comprise a narrow section 30 situated between two broadening sections 32, the broadening sections 32 increasing in size in a direction away from the narrow section 30.

A clamp 34 maybe secured about the inlet 38 of the airbag 36, the clamp 34 being seated over the narrow section 30 such that the airbag 36 and the inflator 10 are secured one to another and in gaseous communication, creating a seal between the inflator 10 and airbag 36. The clamp 34 and indentation 28 maybe, for example, annular.

A clamp 34 is any device that secures the airbag 36 over the indentation 28 of the inflator 10. Often, the clamp 34 will be a crimp ring or other ring-like clamping mechanism. However, it should be noted that the inflator 10 is not necessarily cylindrical so that the clamp 34 may be, for example, square or rectangular in its cross-sectional shape. The clamp 34 may also have the cross-sectional shape of, for example, a skewed circle. In any case, the clamp 34 will be shaped to fit in an airtight manner on the indentation 28. The clamp 34 and the indentation 28 are configured such that they will further secure the seal between the inflator 10 and the airbag 36 when the broadening section 32 is pushed against the clamp 34 by the force of air exiting the inflator 10.

The inlet 38 of the airbag 36 is that portion of the airbag 36 into which the inflator 10 may be inserted. The inlet 38 may be secured between the clamp 34 and the indentation 28 of the inflator 10, creating a seal. The term seal refers to the closure created by the contact between the inflator 10 and the airbag 36. This seal must be airtight during the moment of inflation. Furthermore, the seal must be situated between the apertures 20 and the proximal end 12 so that the inflator 10 is placed in gaseous communication with the airbag 36.

When the inflator 10 is actuated, gas exits the body 16 through the aperture 20 and is directed through the channel 24 into the airbag 36 in a direction away from the proximal end 12 such that the broadening section 32 is pushed against the clamp 34, thereby tightening the seal between the inflator 10 and airbag 36. Also, as the airbag 36 fills, the tension between the airbag 36 and inflator 10 will increase because the gas pushed away from the inflator 10 will impact an increasingly dense and more pressurized gas, again resulting in a tighter seal. Ideally and as illustrated in FIG. 3, the clamp 34 will be placed on the portion of the narrow section 30 immediately adjacent to the broadening section 32. Such placement ensures that the broadening section 32 will be rapidly pushed against the clamp 34, enabling the seal to be tightened at the earliest possible moment.

The gas flow channel 24 directs the gas pushed from the inflator 10 in a direction away from the proximal end 12 of the inflator 10, thus pushing the inflator 10 towards the clamp 34. Many conventional inflators employing a gas outlet diffuser pushed the gas in different directions away from the inflator and thus fail to take advantage of this innovation. In the embodiment shown in FIG. 3, the apertures 20 direct the gas in different directions. However, the gas flow channel 24 then turns and directs the gas from the apertures 20 into the airbag 36, creating the force necessary to secure the seal between the inflator 10 and the airbag 36. In the present invention, the inflator 10 is pushed against the clamp 34 employing the same principle. Therefore, the gas pushed from the inflator 10 must be properly directed so as to push the broadening section 32 of the indentation 28 against the clamp 34.

The cooling and diffusing capabilities of this invention may be employed in an inflator 10 that is not situated within the airbag 36, i.e., the inflator 10 is connected to the airbag 36 by a conduit or tube. However, in such a configuration, the capabilities of this invention to secure the seal between the airbag 36 and inflator 10 will not be employed. Yet, even in this context, this invention still offers substantial advantages over the conventional inflators in the manner in which it cools and diffuses the gas before it enters the airbag 36.

To summarize, this invention presents a significant advancement in the art in that it simultaneously secures the seal between the airbag 36 and the inflator 10, and diffuses and cools the gas in a manner not previously known in the art. More specifically, when the inflator 10 is actuated, the inflator 10 cools and diffuses the gas by directing the gas from the cavity 18 of the inflator body 16, through an aperture 20 in the body 16, along the channel 24 formed by the inflator 10 housing and inflator body 16, and finally into an airbag 36. At the moment of inflation, the counter flow inflator 10 further secures the seal between the inflator 10 and the airbag 36 by directing gas away from the inflator 10 in such a direction that the broadening section 32 of the inflator 10 housing is pushed against a clamp 34 employed to secure the inflator 10 within the airbag 36, thereby tightening the seal between the airbag 36 and inflator 10.

The present invention may be embodied in other specific forms without departing from its scope or essential characteristics. The described embodiments are to be considered in all respects only illustrative, not restrictive. The scope of the invention is, therefore, indicated by the appended claims rather than by the foregoing description. All changes which come within the meaning and range of equivalency of the claims are to be embraced within their scope.

What is claimed and desired to be secured by Letters Patent is:

1. An inflator having a proximal end and a distal end, said inflator comprising:
a body, said body having an interior cavity, said interior cavity being configured such that it is capable of containing a quantity of gas or gas generant material;
an aperture disposed in the body;
a diffuser housing disposed about at least a portion of the body and in cooperation with the body, forming a gas flow channel, said channel being configured such that when the inflator is actuated, gas flows from the cavity, through the aperture, and into the channel, and exits the channel.

2. And inflator as defined in claim 1, wherein the gas exits the channel near the distal end of the inflator.

3. An inflator as defined in claim 1, wherein the channel is at least one-half of the length of the inflator.

4. An inflator as defined in claim 1, wherein the channel is configured such when the inflator is actuated, gas flowing out the inflator is cooled as it flows through the channel.

5. An inflator as defined in claim 1, further comprising a plurality of apertures disposed in the body, said apertures being configured to place the cavity in gaseous communication with the channel.

6. An inflator as defined in claim 5, wherein said apertures are located closer to the proximal end of the inflator than to the distal end.

7. An inflator as defined in claim 1, further comprising a quantity of gas or gas generant material disposed within the interior cavity.

8. An inflator as defined in claim 7, wherein the gas or gas generant material is compressed gas.

9. An inflator as defined in claim 7, wherein the gas or gas generant material is a solid gas generant.

10. An inflator as defined in claim 7, wherein the gas or gas generant material comprises a combination of compressed gas and solid gas generant.

11. An inflator was defined in claim 1, wherein the housing comprises an indentation configured such that it is capable of receiving a clamp.

12. An inflator having a proximal end and a distal end, said inflator comprising:
a substantially cylindrical body, said body having an interior cavity, said interior cavity being configured such that it is capable of containing a quantity of gas or gas generant material;
at least one aperture disposed in the body;
a diffuser housing disposed about at least a portion of said body and in cooperation with the body, forming a gas flow channel, said channel configured such that it is at least one-half of the length of the inflator, and such that when the inflator is actuated, gas flows from the cavity, through the at least one aperture, and into the channel, and exits the channel.

13. And inflator as defined in claim 12, wherein the gas exits the channel near the distal end of the inflator.

14. An inflator as defined in claim 12, wherein the channel is configured such that when the inflator is actuated, gas flowing out the inflator is cooled as it flows through the channel.

15. An inflator as defined in claim 12, further comprising a plurality of apertures disposed in the body, said apertures being configured to place the cavity in gaseous communication with the channel.

16. An inflator as defined in claim 15, wherein said apertures are located closer to the proximal end of the inflator than to the distal end.

17. An inflator as defined in claim 12, further comprising a quantity of gas or gas generant material disposed within the interior cavity.

18. An inflator as defined in claim 17, wherein the gas or gas generant material is compressed gas.

19. An inflator as defined in claim 17, wherein the gas or gas generant material is a solid gas generant.

20. An inflator as defined in claim 17, wherein the gas or gas generant material comprises a combination of compressed gas and solid gas generant.

21. An inflator was defined in claim 12, wherein the housing comprises an indentation configured such that it is capable of receiving a clamp.

22. A vehicle airbag apparatus comprising:
an airbag having an inlet;
an inflator capable of being disposed within the inlet of said airbag, said inflator comprising a distal end, a proximal end, and a body, said body having an interior cavity, said interior being configured such that it is capable of containing a quantity of gas or gas generant material;
an aperture disposed in the body; and
a diffuser housing disposed about at least a portion of the body and in cooperation with the body, forming a gas flow channel, said channel being configured such that when the inflator is actuated, gas flows from the cavity, through the aperture, and into the channel, and exits the channel into the airbag near the distal end of the inflator, said housing further comprising an indentation being configured such that it is capable of receiving a clamp.

23. A vehicle airbag apparatus as defined in claim 22, further comprising a clamp positioned about the inlet of the airbag and seated within the indentation of said body such that said curtain and said inflator are secured one to another.

24. A vehicle airbag apparatus inflator as defined in claim 22, wherein the channel is configured such that when the inflator is actuated, gas flowing out the inflator is cooled as it flows through the channel.

25. A vehicle airbag apparatus as defined in claim 22, further comprising a plurality of apertures disposed in the body, the apertures being configured to place the cavity in gaseous communication with the channel.

26. A vehicle airbag apparatus as defined in claim 25, wherein said apertures are located closer to the proximal end of the inflator than to the distal end.

27. A vehicle airbag apparatus as defined in claim 22, further comprising a quantity of gas or gas generant material disposed within the interior cavity.

28. A vehicle airbag apparatus as defined in claim 27, wherein the gas or gas generant material is compressed gas.

29. A vehicle airbag apparatus as defined in claim 27, wherein the gas or gas generant material is a solid gas generant.

30. A vehicle airbag apparatus as defined in claim 27, wherein the gas or gas generant material comprises a combination of compressed gas and solid gas generant.

31. A vehicle airbag apparatus as defined in claim 22, wherein the airbag comprises an inflatable curtain.

32. A method for inflating a vehicle airbag comprising the steps of:
a. providing an airbag;
b. providing an inflator comprising a distal end, a proximal end, and a body, said body having an interior cavity, said interior cavity containing a quantity of gas generant material; an aperture disposed in the body; a diffuser housing disposed about at least a portion of the body and in cooperation with the body, forming a gas flow channel, said channel configured such that upon operation of the inflator, gas flows from the cavity, through the aperture, and into the channel, and exits the channel into the airbag near the distal end of the inflator, said housing further comprising an indentation configured such that it is capable of receiving an clamp;
c. placing said inflator in gaseous communication with said airbag; and
d. actuating said inflator such that gas exits said body through said aperture and is directed through said channel into said airbag.

33. A method as defined in claim 32, wherein said gas is cooled as it flows through said channel.

34. A method as defined in claim 32, wherein said airbag comprises an inflatable curtain.

35. A method of inflating an airbag and simultaneously tightening a seal between an inflator and said airbag comprising the steps of:
a. providing an airbag having an inlet;
b. providing an inflator comprising a distal end, a proximal end, and a body, said body having an interior cavity, said interior cavity containing a quantity of gas generant material; an aperture disposed in the body; a diffuser housing disposed about at least a portion of the body and in cooperation with the body, forming a gas flow channel, said channel configured such that upon operation of the inflator, gas flows from the cavity, through the aperture, and into the channel, and exits the channel into the airbag near the distal end of the inflator; said housing further comprising an indentation configured such that it is capable of receiving a clamp, the indentation comprising a narrow section and a broadening section, the narrow section abutting the broadening section and being situated between the proximal end and the broadening section;
c. securing a clamp about the inlet of the airbag, the clamp being seated over the narrow section of the indentation such that said curtain and said inflator are secured one to another and in gaseous communication, creating a seal between the inflator and airbag; and
d. actuating said inflator such that gas exits said body through said aperture and is directed through said channel into said airbag, said gas exiting the inflator near the distal end and in a direction away from the proximal end such that the broadening section is pushed against the clamp, thereby tightening the seal between the inflator and airbag.

36. A method as defined in claim 35, wherein said gas is cooled as it flows through said channel.

37. A method as defined in claim 35, wherein said airbag comprises an inflatable curtain.
